(19) United States
(12) Patent Application Publication
(10) Pub. No.: US 2007/0115252 A1
(43) Pub. Date: May 24, 2007

(54) 3-D cursor control system

(75) Inventor: Tom Burgmans, Boschdijk (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/586,934

(22) PCT Filed: Jan. 27, 2005
(86) PCT No.: PCT/IB05/50368

§ 371 Date: Jul. 24, 2006

Related U.S. Application Data
(60) Provisional application No. 60/540,712, filed on Jan. 30, 2004.

(51) Int. Cl. G09G 5/00

(52) U.S. Cl. 345/156

(57) ABSTRACT

A 3-D cursor control system includes a remote control unit (20) which emits ultrasonic waves. Ultrasonic sensors (14a,14b,14c) measure changes in the position of the remote control unit (20) for controlling the position of a cursor on a display. The ultrasonic sensors (14a,14b,14c) also measure the distance that the remote control unit (20) is removed from the sensors (14a,14b, 14c). This distance measurement is then used to adjust the sensitivity of the 3-D cursor control system such that the cursor moves on the display in accordance with the same movement of the remote control (20) regardless of distance of the remote control unit (20) from the ultrasonic sensors (14a,14b,14c).

The subject invention relates to remote controls for controlling a cursor on a display device.

Remote controls have been around for many years and are used for controlling various consumer electronics products, for example, television receivers. When used with television receivers, the remote control is able to control various operating functions of the television receiver, for example, channel selection, volume, etc. In more recent remote control systems, the remote control includes “arrow” keys for moving a “highlight” area to various predetermined areas on the display screen for the purpose of selecting/setting various functions of the television receiver.

In the computer area, remote controls are also known, in the form of, for example, a computer mouse, for moving a cursor around the computer display screen, again for the purpose of selecting/setting various functions.

With the advent of computer video games playable on a television receiver, the need has arisen for a mouse-type remote control for, for example, moving a cursor around on the display of a television receiver.

U.S. Pat. No. 5,999,167 discloses a cursor control device in which the movements of a handheld remote control are detected by an ultrasonic transmitter on the television receiver and an array of ultrasonic receivers on the handheld remote control, in which control signals are transmitted to the television receiver via an infrared transmitter on the handheld remote control and an infrared receiver on the television receiver.

While this system works adequately, the response of the system is dependent on the distance that a user is removed from the television receiver. When a user is relatively close to the television receiver, a certain amount of movement of the handheld remote control translates to a corresponding movement of a cursor on the television receiver. However, when the use is relatively distant from the television receiver, in order to achieve the same corresponding movement of the cursor, the user needs to make highly exaggerated movements of the handheld remote control.

It is an object of the invention to provide a 3-D cursor control system which is insensitive to the distance that a user is removed from a controlled device.

The above object is achieved in a cursor control system comprising a handheld remote control unit having means for transmitting control signals to a controlled device, said handheld remote control unit further having means for transmitting an ultrasonic position signal; receiving means for receiving said control signals and for applying said received control signals to said controlled device for controlling various functions of said controlled device; an ultrasonic sensor array for receiving said ultrasonic position signal; and means coupled to said ultrasonic sensor array for detecting movements of said handheld remote control unit and for applying cursor position signals to said controlled device for moving a cursor on a display of said control device correspondingly to said movements of said handheld remote control unit, the movement of the cursor in relation to the detected movement of the handheld remote control unit being at a predetermined ratio, wherein said means for determining movements of said handheld remote control unit comprises means for modifying a sensitivity of said ultrasonic sensor array such that said predetermined ratio remains constant, whereby movements of the handheld remote control unit when relatively distant from the controlled device result in the same movement of the cursor as when the handheld remote control unit is similarly moved when relatively close to the controlled device.

In such a cursor control system, the distance that the remote control unit is from the ultrasonic sensor array is continuously being monitored, and the sensitivity of the cursor control system is continuously being modified based on the detected distance such the ratio of movement of the remote control unit relative to that of the cursor is kept constant. As such, the same comfortable movement of the remote control unit is used to move the cursor relatively, regardless of the distance that the remote control unit is from the ultrasonic sensor array.

With the above and additional objects and advantages in mind as will hereinafter appear, the invention will be described with reference to the accompanying drawings, in which:

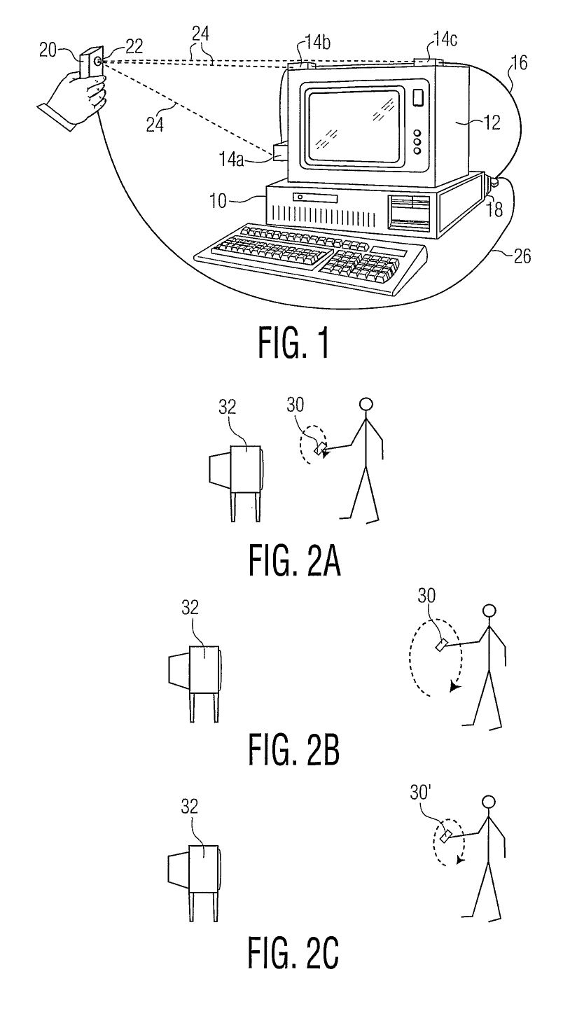

FIG. 1 shows a prior art three-dimensional computer mouse system;

FIG. 2A shows a graphic drawing of a person using a prior art three-dimension cursor control system from a close distance, while FIG. 2B shows a graphic drawing of the same person using the same prior art three-dimensional cursor control system from a far distance, and FIG. 2C shows a graphic drawing of the same person using the cursor control system of the subject invention from a far distance;

FIG. 3A shows a graphic drawing illustrating the difference between the movement of a handheld unit when close to the receiver and when distant from the receiver;

FIG. 3B shows another graphic drawing illustrating the difference between the movement of a handheld unit when close to the receiver and when distant from the receiver;

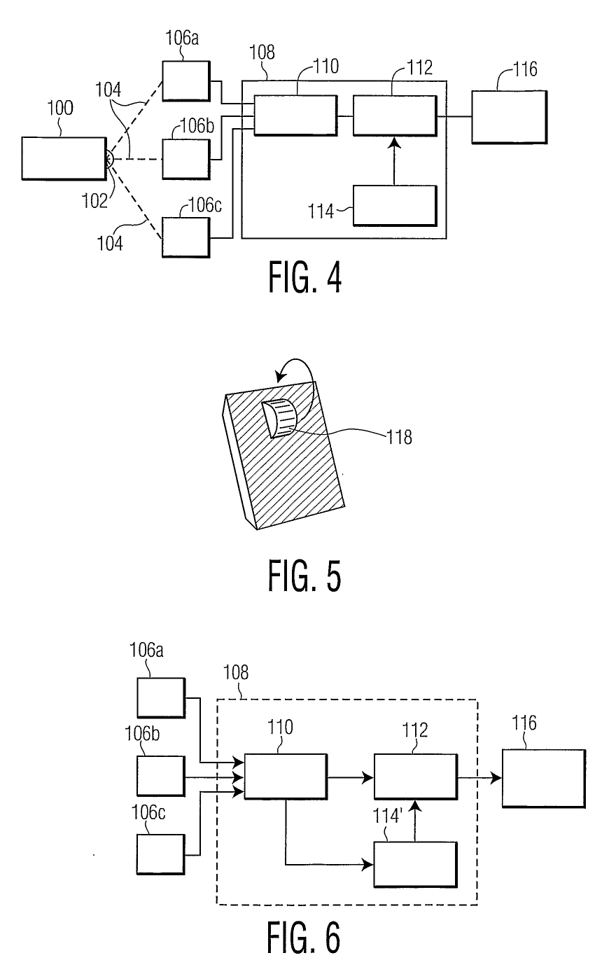

FIG. 4 shows a block circuit diagram of a three-dimensional cursor control system of the subject invention;

FIG. 5 shows a block circuit diagram of a first embodiment of a sensitivity adjuster for the 3-D cursor control system shown in FIG. 4;

FIG. 6 shows a block circuit diagram of a second embodiment of a sensitivity adjuster for the 3-D cursor control system as shown in FIG. 4; and

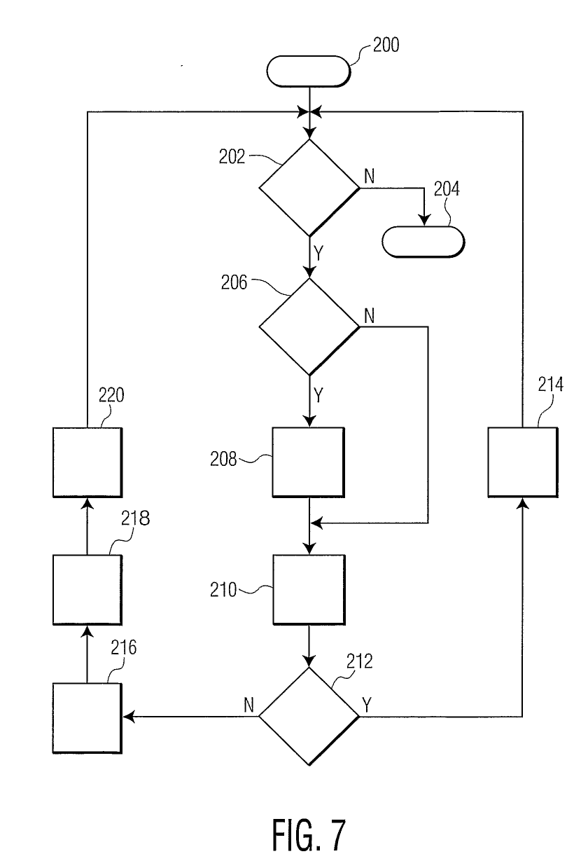

FIG. 7 shows a flowchart of the processing in the microprocessor for effecting a second embodiment of the invention.

FIG. 1 shows a known three-dimensional control system for use with a personal computer. The system includes a personal computer 10 having a monitor 12 for displaying images. An array of ultrasonic sensors 14a, 14b and 14c are arranged around the periphery of the monitor 12, and communicate with the personal computer 10 via a bus 16 cooperating with an input port 18. A 3-D mouse 20 is shown in the hand of a user and includes an ultrasonic transmitter 22 for emitting ultrasonic waves 24 which are detected by the ultrasonic sensors 14a, 14b, 14c. The 3-D mouse receives operating power from and communicates control signals to the personal computer 10 via bus 26.

The 3-D control system uses ultrasonic waves and the Doppler effect to control the movement of a cursor on the display of the monitor 12. In particular, the three sensors 14a, 14b, 14c, arranged in a triangle around the monitor 12, measure the difference between the received sound signal and a reference value. For example, when the transmitter, i.e., the 3-D mouse 20, moves toward a sensor, the received signal will be larger than the original signal due to the Doppler effect. Thus, one sensor is sufficient to measure the difference in the distance of the 3-D mouse with respect to the sensor. By using 3 sensors positioned in a triangle, the absolute distances between the transmitter and each sensor can be measured. This makes it possible to control the cursor with the 3-D mouse just by moving it through the air.

While this known system works reasonably well, Applicant notes that it has shortcomings. In particular, consider the distance of an ultrasonic transmitter to the receiver (one of the three sensors) as a vector (x, y, z) whereby the receiver is at point (0, 0, 0) and the transmitter's initial point is somewhere on the x-axis. The closer the ultrasonic transmitter is to the receiver (the smaller the x-component of the vector), the larger are its phase shifts whenever a movement is made in the y-z field. In other words, in the case of the controlled device being a television receiver, if you are close to television receiver with your 3-D remote control, you can make relatively small and slow y-z movements compared to what you have to do from a large distance in order to have the same cursor behavior. In fact, phase shifting is only a result of the difference between the initial distance and the end distance during a certain period of time. Large distances from the receiver mean bigger movements in the y-z field should be made in order to make a relevant difference between the initial distance and the end distance.

This effect is shown graphically in FIGS. 2A and 2B, in which, as shown in FIG. 2A, small (and comfortable) movements of the 3-D remote control 30 are used to control a cursor on a television receiver 34, while, as shown in FIG. 2B, large (and relatively uncomfortable) movements of the 3-D remote control 30 are needed to effect the same cursor movements.

As shown in FIG. 3A, the receiver 34 (at the television receiver 32) interprets a movement Y(1) of the 3-D remote control 30 in the Y direction at a distance of X(1) from the receiver 34, the same as a movement Y(2) of the 3-D remote control 30 in the Y direction at a distance of X(2) from the receiver 34. FIG. 3B illustrates the situation in another manner: “a” is the absolute distance from the transmitter 30 (at point T1) to the receiver 34 (at point R). “b” is the movement the transmitter 30 is going to make (from point T1 to point T2). “c” is the change in absolute distance which is caused by movement “b”. Because of this change “c”, phase-shifting will occur at the transmitted sound (or any other kind of wave). When “a” becomes larger, “b” should be bigger in order to have the same “c”. This is shown in the formula:
b=\sqrt{(2a+c)*c}

FIG. 4 shows a block circuit diagram of the 3-D cursor control system of the subject invention. A remote control unit 100 includes an ultrasonic transmitter 102 for emitting ultrasonic waves 104. These ultrasonic waves 104 are detected by ultrasonic sensors 106a, 106b and 106c. The outputs from the sensors 106a, 106b and 106c are applied to a cursor controller 108 including a movement detector 110 for detecting movements of the remote control unit 100 using the output signals from the sensors 106a, 106b and 106c, a cursor positioner 112, for positioning a cursor based on the movements detected by the movement detector 110, and a sensitivity adjuster 114. The sensitivity adjuster 114 modifies a sensitivity of the cursor positioner 112 to maintain constant a ratio of a movement of a cursor to a detected movement of the remote control unit 100, thereby compensating for the distance of the remote control unit 100 from the sensors 106a, 106b and 106c. The output from the cursor controller 108 is applied to a display 116.

One embodiment of the sensitivity adjuster 114 is shown, graphically, in FIG. 5 in which the remote control unit 100 includes a variable control 118 which generates a control signal variable by a user of the remote control unit 100. This control signal may then be transmitted to the sensitivity adjuster 114 via standard infrared signals (not shown). The user is then able to adjust the sensitivity of the cursor control system such that a movement of the remote control unit 100 relative to a movement of the cursor can be kept constant such that a comfortable movement of the remote control unit 100 is achieved regardless of the distance from the sensors 106a, 106b, 106c.

A second embodiment of the sensitivity adjuster 114′ is shown in the block circuit diagram of FIG. 6. The outputs from the sensors 106a, 106b and 106c are applied to the cursor controller 108′, which includes the movement detector 110 for detecting movements of the remote control unit 100 using the output signals from the sensors 106a, 106b and 106c. The output from the movement detector 110 is applied to the cursor positioner 112 for moving a cursor on the display 116. In addition, the output from the movement detector 110 is applied to the sensitivity adjuster 114′ which then detects the distance that the remote control unit 100 is from the sensors 106a, 106b and 106c. Based on this determined distance, the sensitivity adjuster 114′ applies a control signal to the cursor positioner 112 for modifying the sensitivity thereof such that a ratio of the movement of the remote control unit 100 relative to a movement of the cursor remains constant. As such, a user of the sensor control system is not aware of any changes and the cursor moves on the display screen with the same movements of the remote control unit regardless of the distance from the sensors 106a, 106b and 106c.

FIG. 7 shows a flowchart explaining the operation of the embodiment of FIG. 6. From a START position 200, at step 202 the cursor control system detects whether a CURSOR key is depressed on the remote control unit 100. If not, the routine is exited at step 204. If, at step 202, it is determined that the CURSOR key is depressed, at step 206, it is determined whether a CALIBRATION key is also being depressed. This is done by the user at a known distance from the sensors 106a, 106b and 106c. At step 208, the cursor control system determines a ratio R of a movement of the cursor to a desired movement of the remote control unit, determines a sensitivity setting S_{DEFAULT} of the cursor control system based on the ratio R and the known distance, and sets the distance D at a default value D_{DEFAULT}, i.e., the known distance. This marks the end of the calibration phase.

The cursor control system is now in the operating phase and proceeds to step 210. If, in step 206, it is determined that the CALIBRATION key is not depressed, the system jumps to step 210.

At step 210, the cursor control system measures the current distance D_{MEASURE} to the remote control unit 100. In step 212, the cursor control system determines if the measured distance D_{MEASURE} is equal to the stored distance D. If so, at step 214, the cursor control system pauses for a predetermined amount of time (to prevent the system from acting too quickly) and then reverts to step 202. If, at step 212, the measured distance D_{MEASURE} is not equal to the stored distance D, at step 216, the cursor control system calculates a new sensitivity setting S_{CALC} based on the measured distance D_{MEASURE} such that the ratio R remains constant, and, at step 218 sets the sensitivity setting S to be equal to S_{CALC} and the distance D to D_{MEASURE}. At step 220, the cursor control system pauses for a predetermined amount of time and then reverts to step 202.

Numerous alterations and modifications of the structure herein disclosed will present themselves to those skilled in the art. However, it is to be understood that the above described embodiment is for purposes of illustration only and not to be construed as a limitation of the invention. All such modifications which do not depart from the spirit of the invention are intended to be included within the scope of the appended claims.

1. A cursor control system comprising:
a handheld remote control unit (100) having means for transmitting control signals to a controlled device (32), said handheld remote control unit (100) further having means for transmitting (102) an ultrasonic position signal;
receiving means for receiving said control signals and for applying said received control signals to said controlled device (32) for controlling various functions of said controlled device (32);
an ultrasonic sensor array (106a, 106b, 106c) for receiving said ultrasonic position signal; and
means (108, 110, 112), coupled to said ultrasonic sensor array (106a, 106b, 106c), for detecting movements of said handheld remote control unit (100) and for applying cursor position signals to said controlled device (32) for moving a cursor on a display (116) of said control device (32) correspondingly to said movements of said handheld remote control unit (100), the movement of the cursor in relation to the detected movement of the handheld remote control unit (100) being at a predetermined ratio,
wherein said means (108, 110, 112)) for detecting movements of said handheld remote control unit (100) comprises means (114) for modifying a sensitivity of said ultrasonic sensor array (106a, 106b, 106c) such that said predetermined ratio remains constant, whereby movements of the handheld remote control unit (100) when relatively distant from the controlled device (32) result in the same movement of the cursor as when the handheld remote control unit (100) is similarly moved when relatively close to the controlled device (32).

2. The cursor control system as claimed in claim 1, wherein said modifying means (114) comprises a manually operable variable control (118) on said handheld remote control unit (100) coupled to said control signal transmitting means for transmitting a sensitivity setting signal to said controlled device (32) for said detecting means (108, 110, 112) wherein said sensitivity setting signal modifies said sensitivity of said ultrasonic sensor array (106a, 106b, 106c).

3. The cursor control system as claimed in claim 1, wherein said modifying means comprises means (112) coupled to said ultrasonic sensor array (106a, 106b, 106c) for determining a distance of said handheld remote control unit (100) from said ultrasonic sensor array (106a, 106b, 106c), and means (114′) for modifying said sensitivity based on said determined distance.

4. A method of controlling movements of a cursor on a display (116) based on movements of a 3-D remote control unit (100), said method comprising the steps:
detecting the 3-D remote control unit (100) at a predetermined distance from a receiver (106a, 106b, 106c);
determining (108, 110, 112) a ratio of movement of the cursor to movement of the 3-D remote control unit (100) based on a sensitivity setting of said receiver and said predetermined distance; and
measuring a current distance (106a, 106b, 106c, 110) of the 3-D remote control unit (100) from the receiver, and modifying the sensitivity setting (114′) of said receiver based on the measured current distance such that said ratio remains constant.
